(19) United States
(12) Patent Application Publication
(10) Pub. No.: US 2003/0196962 A1
(43) Pub. Date: Oct. 23, 2003

(54) Process for selective removal of toxic ions from water

(76) Inventors: William Fries, Southampton, PA (US); Francis Boodoo, King of Prussia, PA (US)

Correspondence Address: Herbert B. Keil, KEIL & WEINKAUF, 1350 Connecticut Ave., N.W., Washington, DC, 20036, US

(21) Appl. No.: 10/126,577

(22) Filed: Apr. 22, 2002

(51) Int. Cl. C02F 1/42

(52) U.S. Cl. 210/681

(57) ABSTRACT

Water is treated by an ion exchange process that removes toxic ions, but does not significantly change the non-toxic ion concentration.

### BACKGROUND

Drinking water must be free of highly toxic ions such as the anions bromide, the arsenates, selenate, cyanide, etc., and the cations of manganese and chromium, lead, copper, mercury, etc. Ion exchange resins have frequently been used to purify drinking water. In some cases, relatively selective ion exchange systems have been disclosed in the prior art.

For example, Solt et al., U.S. Pat. No. 5,086,185, discloses a method of selectively removing nitrate ions from water containing high concentrations of sulfate ions.

Selective removal of nitrate from water containing both nitrates and sulfates has also been disclosed by Gutt, U.S. Pat. No. 4,479,877.

However, the prior art has not disclosed a versatile process for removing highly toxic ions, e.g., anions such as bromide, arsenate, selenate and cyanide and the cations of magnesium, calcium and chromium, from drinking water without changing the content of essentially innocuous ions, such as sulfate, chloride and bicarbonate anions land sodium, magnesium and potassium cations, which hereinafter may be referred to as “background” ions.

### SUMMARY OF THE INVENTION

The object of applicants' process is to provide essentially completely selective toxic ion removal, along with possible removal of other undesirable ions, such as nitrate and phosphate, with little or no change in benign background ions, i.e., sulfate, chloride and bicarbonate, in the case of toxic anion removal, and sodium, magnesium, calcium and potassium, in the case of toxic cation removal.

The foregoing object is achieved by treatment of the starting material water with an ion exchange resin that has been pretreated to bring it into equilibrium with the innocuous background ions present in the water being treated.

### DETAILED DESCRIPTION OF THE INVENTION

There are commercially available ion exchange resins that are at least relatively selective to one or more of the toxic ions removed by applicant's process. Applicant's process enables the use of those ion exchange resins with potential drinking water from almost any source with almost any background ion concentrations without the dramatic change in background ion concentration normally experienced.

A particularly valuable use for applicants' process is in the production of bottled water. Bottlers of drinking water want their product to be essentially “natural” and to have essentially the same aesthetics, i.e., taste and odor, except for the obviously necessary removal of toxins such as toxic ions. Applicant has discovered that the change in aesthetics normally experienced is caused by the change in background ion concentration normally experienced when toxic ions are removed by known processes.

As has been stated above, there are already commercially available ion exchange resins, both anion and cation, which have known selectivity to specific toxic ions. The challenge has been to develop a process that would enable the use of those resins in a variety of waters containing different profiles of non-toxic ion content in an economic fashion, i.e., the resin system is capable of being used in an indefinite number of cycles of toxic ion removal and regeneration.

The initial step is selection of an ion exchange resin having the known relative selectivity. With regard to anions, bromide will be the toxic anion discussed and illustrated in the working examples to follow. The specific background ions that will be exemplified are sulfate, chloride and bicarbonate and the additional, only slightly toxic anions are nitrate and phosphate.

In the case of toxic cations, manganese and chromium will be illustrative toxic ions and calcium, magnesium, sodium and potassium will be the illustrative background ions.

The water to be treated is preliminarily analyzed for background ion concentration, and the ion exchange resin is then treated with a solution having an appropriate ion concentration to provide the appropriate loading of the resin with those ions so that it will be in equilibrium with the water to be treated, i.e., the concentration of those ions in the treated drinking water will not be greatly changed. The appropriate treating concentration is determined experimentally. One of ordinary skill in this art will be enabled at least to estimate the appropriate loading and the concentration of loading US solution for any given starting water from the results of the following working examples, and in any event, no more than ordinary skill will be required to practice this invention with any toxic ion and any combination of background ions.

Finally, the exhausted resin, i.e., when the effluent exceeds the desired content of toxic ion or variation of background ions, is regenerated. The original commercial anion exchange resin is usually in the chloride form, but regeneration can be carried out with approximately 5% solutions of any one of sodium chloride, sodium nitrate or sulfuric acid to obtain the resin in chloride, nitrate or sulfate form, respectively.

Commercial cation exchange resins are generally available as the sodium salt form or, in some instances, as the free acid. They can be regenerated to the desired form using hydrochloric acid or sodium chloride and sodium hydroxide.

The following examples illustrate the present invention.

### EXAMPLE 1

An exemplary water to be treated had the following anion content:

Bromide=1.0 ppm

Nitrate=0.107 meq/l Trace

Phosphate=0.022 meq/l Trace

Sulfate=0.175 meq/l

Chloride=0.371 meq/l

Bicarbonate=1.200 meq/l

Seven columns packed with the strong base resin Purolite Bromide Plus, a styrene/divinylbenzene (S/DVB) resin containing quaternary ammonium groups, in the chloride form were loaded with the exemplary solution.

To determine the requirements for regeneration to the pure chloride form, a solution of 50 g/l sodium chloride was passed through the columns in bed volumes varying from 17 to 100. It was found that 17 bed volumes was sufficient to completely regenerate the ion exchange resin to the chloride form.

### EXAMPLE 2

Solutions of varying concentrations of sodium sulfate, sodium chloride and sodium bicarbonate were used to load the regenerated ion exchange beds from Example 1. It was found that 38 bed volumes of a solution having the following composition was optimum for treating the ion exchange resin to convert it to the optimum loading to treat the exemplary water:

Sodium sulfate=1.344 eq/l

Sodium chloride=0.0185 eq/l

Sodium bicarbonate=0.080 eq/l

### EXAMPLE 3

The ion exchange resin column charged with 38 bed volumes of the solution described in Example 2 was used to purify the exemplary solution described in Example 1. The following table shows the resin effluent composition of the relevant anions as the percentage change in the initial concentration in the effluent after the indicated number of bed volumes had been passed through the column:

| Bed volumes | Br⁻ | NO₃⁻ | PO₄⁻³ | SO₄⁻² | Cl⁻ | HCO₃⁻ |
|---|---|---|---|---|---|---|
| 31 | −100 | −95 | −94 | −9 | +14 | +7 |
| 89 | −100 | −97 | −82 | −4 | +16 | +6 |
| 179 | − | −92 | — | −10 | +20 | −2 |
| 286 | −100 | −98 | −35 | +3 | +12 | +5 |
| 759 | −100 | −98 | −5 | −4 | +6 | +6 |
| 946 | −100 | −94 | — | +8 | −6 | +7 |
| 1359 | −100 | −89 | — | +7 | +2 | +8 |
| 1499 | −100 | −89 | — | +3 | +2 | +8 |
| 1859 | −100 | −85 | — | +1 | +10 | +13 |

### EXAMPLE 4

The resin column from Example 3 was regenerated using a 5% sulfuric acid solution, and two other columns which had been used identically were regenerated using 4% sodium nitrate solution and 5% sodium chloride solution, respectively. The results of the regeneration process are set forth below.

| 5% H₂SO₄ | | 4% NaNO₃ | | 5% NaCl | |
|---|---|---|---|---|---|
| | Br- content | | Br- content | | Br- content |
| BV | in effluent | BV | in effluent | BV | in effluent |
| 0.5 | 0.0 ppm | 0.88 | 0.0 ppm | 2.5 | 30 ppm |
| 1.5 | 10 ppm | 1.78 | 36 ppm | 5.0 | 96 ppm |
| 2.5 | 135 ppm | 2.22 | 336 ppm | 6.2 | 59 ppm |
| 4.5 | 158 ppm | 3.33 | 272 ppm | 7.8 | 32 ppm |
| 5.5 | 186 ppm | 4.0 | 18 ppm | 10.7 | 28 ppm |
| 6.3 | 158 ppm | 4.6 | 8 ppm | 13.7 | 5.0 ppm |
| 8.7 | 90 ppm | 5.35 | 0.0 ppm | 16.8 | 11 ppm |
| 10.7 | 90 ppm | | | 19.7 | 12 ppm |
| 13.4 | 28 ppm | | | | |
| 16.7 | 13 ppm | | | | |

### EXAMPLE 5

Seven additional water samples of varying background ion content were treated as in Examples 1 and 2 to determine the salt levels required in the loading solution to obtain a loaded resin which would achieve equilibrium with the corresponding exemplary waters, i.e., to remove essentially all bromide with no more than approximately a ±10% change in innocuous ion content. The results are as follows. Note that 5a represents the results obtained with the exemplary water of Examples 1 and 2.

| | | | | | Resin loading | | |
|---|---|---|---|---|---|---|---|
| Water composition, meq/l | | | | | solution composition eq/l | | |
| | NO₃⁻ | SO₄⁻² | Cl⁻ | HCO₃⁻ | SO₄⁻² | Cl⁻ | HCO₃⁻ |
| a) | 0.107 | 0.175 | 0.371 | 1.200 | 1.344 | 0.0185 | 0.080 |
| b) | 0.000 | 0.0771 | 0.423 | 0.262 | 0.550 | 0.022 | 0.020 |
| c) | 0.145 | 0.145 | 0.0857 | 1.28 | 0.210 | 0.0023 | 0.039 |
| d) | 0.020 | 0.000 | 0.140 | 0.800 | 0.000 | 0.14 | 1.200 |
| e) | 0.023 | 0.458 | 0.048 | 2.787 | 0.199 | 0.002 | 0.049 |
| f) | 0.087 | 0.438 | 0.338 | 4.098 | 0.170 | 0.0045 | 0.066 |
| g) | 0.1177 | 0.1313 | 0.0930 | 1.830 | 0.2020 | 0.002 | 0.0460 |
| h) | 0.087 | 0.438 | 0.338 | 5.000 | 0.720 | 0.0078 | 0.160 |

Each water sample had a bromide content similar to that of Example 1, i.e., Example 5a, and in each case the resulting innocuous ion loaded resin was capable of removing essentially all of that bromide.

One of ordinary skill in this art could carry out the experimentation illustrated in Example 2 to discover an appropriate loading for any particular water. The results obtained in Example 5 with starting waters of widely differing compositions would provide an estimated composition to serve as a basis for optimization.

### EXAMPLE 6

The water treated had essentially the same ion content as that in Example 5g) above. In this case, however, the resin was also loaded with nitrate to illustrate that the nitrate ion concentration may be essentially unchanged, i.e., within ±10% change in the original concentration if it is so desired.

| | | | | Resin loading | | | |
|---|---|---|---|---|---|---|---|
| Water composition, meq/l | | | | solution composition eq/l | | | |
| NO₃⁻ | SO₄⁻² | Cl⁻ | HCO₃⁻ | NO₃⁻ | SO₄⁻² | Cl⁻ | HCO₃⁻ |
| 0.1177 | 0.1313 | 0.0930 | 1.830 | 0.00560 | 0.2020 | 0.002 | 0.0460 |

The following table shows the resin effluent composition of the relevant anions as the percentage change in the initial concentration in the effluent after the indicated number of bed volumes had been passed through the column.

| Bed volumes | NO₃⁻ | SO₄⁻² | Cl⁻ | HCO₃⁻ |
|---|---|---|---|---|
| 40 | +1 | −2 | −3 | +1 |
| 85 | −7 | +5 | +7 | 0 |
| 168 | −6 | −+2 | 0 | +1 |
| 300 | −3 | −9 | −3 | +1 |
| 380 | −2 | +15 | 0 | −1 |
| 570 | −4 | +28 | +3 | −2 |
| 616 | −3 | +27 | 0 | −1 |
| 712 | −4 | −18 | 0 | +2 |
| 796 | −4 | −22 | −3 | +3 |
| 850 | −4 | −13 | +3 | +2 |
| 970 | −3 | +18 | 0 | +8−1 |
| Average* | ** | +3 | +0.4 | +0.5 |

*The average is appropriate because the analytical results for these three ions is obviously random around these averages. The analytical technique used for each was not sensitive enough to detect real trends, but sufficiently accurate to demonstrate the conclusion of <±10% leakage after averaging.
**The analytical technique for the NO⁺³ ion is quite good, and shows a real trend, but still within the ±10% limits.

### EXAMPLE 7

This example illustrates the removal of chromium (Cr).

The water to be treated had an unacceptable chromium ion content above 0.05 ppm. After treatment, the (Cr-3) level was well below 0.05 ppm. The ion exchange resin used in this instance was Purolite C100, which is a well known, commercially available, strong acid cation exchanger based on a sulfated S/DVB copolymer. The water composition and the resin loading solution required to equilibrate the resin are set forth in the table below.

| | |
|---|---|
| Water composition, meq/l | Resin loading solution composition eq/l |

| Ca⁺² | Mg⁺² | K⁺ | Na⁺ | CaCl₂ | MgCl₂ | KCl | NaCl |
|---|---|---|---|---|---|---|---|
| 2.45 | 1.65 | 0.0181 | 0.808 | 0.62 | 0.35 | 0.0090 | 0.079 |

The following table shows the resin effluent composition of the relevant cations as the percentage change in the initial concentration in the effluent after the indicated number of bed volumes had been passed through the column.

| | Water composition | | | | |
|---|---|---|---|---|---|
| Bed | | | | | Total Ca⁺² + |
| Volume | K⁺ | Na⁺ | Ca⁺² | Mg⁺² | Mg⁺² |
| 123 | −5 | −10 | — | — | −2 |
| 143 | | | — | — | −2 |
| 435 | — | — | 0 | −5 | −5 |
| 494 | — | — | — | −2 | — |

The results of this example illustrate that chromium content can be reduced to an acceptable level with the innocuous cation concentration being changed less than ±0% with respect to the initial concentration.

### EXAMPLE 8

The acceptable level of manganese content in drinking water under EPA regulations is 0.05 ppm. This example illustrates the reduction of manganese content from 0.08 ppm to well below 0.05 ppm. The strong acid ion exchange resin used is known as Diphonix. It is a S/DVB resin with both sulfonic acid and gem-diphosphonic acid groups. This resin is disclosed in greater detail in an article by R. Chiarizia et al. in Solvent Extraction and Ion Exchange, 11 (5), 967-985, 1993. This example is a scale up of the removal of manganese while maintaining the innocuous ions calcium, magnesium and sodium within the range of a ±10% change from the initial concentration. The resin initially is in the sodium form. The bed volume (BV) of resin is 375 US gallons, and the equilibrating solution is 3750 US gallons (10 BV) containing 732 pounds of calcium chloride and 239 pounds of magnesium chloride hexahydrate. The thus equilibrated resin is rinsed with approximately 3750 gallons (10 BV) prior to use. The table below illustrates the relatively constant concentration of innocuous ions in the treated water compared to the feed water.

| Sample no. | BV | Ca⁺², ppm | Mg⁺², ppm | Na⁺, ppm |
|---|---|---|---|---|
| feed | | 10.68 | 0.72 | 2.92 |
| 1 | 0-20 | 6.00 | 0.52 | 2.83 |
| 2 | 21-40 | 6.20 | 0.56 | 3.30 |
| 3 | 41-60 | 8.92 | 0.85 | 2.87 |
| 4 | 61-80 | 9.54 | 1.01 | 2.95 |
| 5 | 81-100 | 10.64 | 0.98 | 2.98 |
| 6 | 101-120 | 10.76 | 0.98 | 3.00 |
| 7 | 121-140 | 10.04 | 1.02 | 2.81 |
| 8 | 141-160 | 10.60 | 1.02 | 2.82 |

Examples 7 and 8 will provide one of ordinary skill in this art with the necessary guidance to perform toxic cation removal without undue change in the innocuous cation content without the exercise of undue experimentation.

1. A process for removing toxic ions from water without significantly changing the concentration of non-toxic ions in said water which comprises treating said water with an ion exchange resin which has been pretreated with a solution having a non-toxic ion concentration such that the treated water has a non-toxic ion concentration similar to that of said water to be treated.

2. The process of claim 1, wherein said toxic ions and said non-toxic ions are anions and said ion exchange resin is an anion exchange resin.

3. The process of claim 2, wherein said anion exchange resin is a strong base anion exchange resin.

4. The process of claim 3, wherein said ion exchange resin is a styrene/divinylbenzene resin containing quaternary ammonium groups.

5. The process of claim 3, wherein said toxic ions are selected from the group consisting of bromide, arsenate, selenate and cyanide.

6. The process of claim 3, wherein said non-toxic ions are selected from the group consisting of sulfate, chloride and carbonate.

7. The process of claim 1, wherein the content of said non-toxic ions in the treated water varies by no more than ±10% from said water to be treated.

8. The process of claim 3, wherein the content of said non-toxic anions in the treated water varies by no more than ±10% from said water to be treated.

9. The process of claim 1, wherein said toxic ions and said non-toxic ions are cations and said ion exchange resin is a cation exchange resin.

10. The process of claim 9, wherein said cation exchange resin is a strong acid cation exchange resin.

11. The process of claim 10, wherein said ion exchange resin is a styrene/divinylbenzene resin containing sulfonic acid groups.

12. The process of claim 9, wherein said cation exchange resin is a styrene/divinylbenzene resin containing both sulfonic acid and gem-diphosphonic acid groups.

13. The process of claim 9, wherein said toxic ions are selected from the group consisting of chromium and manganese ions.

14. The process of claim 9, wherein said non-toxic ions are selected from the group consisting of calcium, magnesium, sodium and potassium.

15. The process of claim 9, wherein the content of said non-toxic ions in the treated water varies by no more than ±10% from said water to be treated.

16. The process of claim 10, wherein the content of said non-toxic anions in the treated water varies by no more than ±10% from said water to be treated.
